(19) United States
(12) Patent Application Publication
(10) Pub. No.: US 2008/0038493 A1
(43) Pub. Date: Feb. 14, 2008

(54) Packing Sleeve for a Cylinder in a Printing Press

(75) Inventor: Jilani Chrigui, Creil (FR)

Correspondence Address: DAVIDSON, DAVIDSON & KAPPEL, LLC, 485 SEVENTH AVENUE, 14TH FLOOR, NEW YORK, NY, 10018, US

(73) Assignee: GOSS INTERNATIONAL MONTATAIRE SA, Montataire (FR)

(21) Appl. No.: 10/593,688

(22) PCT Filed: Mar. 21, 2005
(86) PCT No.: PCT/IB05/00722

§ 371 Date: Apr. 30, 2007

(30) Foreign Application Priority Data
Mar. 19, 2004 (DE) 2004 013 552.5

(51) Int. Cl. B41F 27/10

(52) U.S. Cl. 428/34.1; 101/484

(57) ABSTRACT

A packing sleeve having an evacuatable structure of voids is disclosed, for a cylinder in a printing press, especially a printing plate cylinder or a blanket cylinder. The inner diameter of the packing sleeve can be varied by applying a negative pressure to the evacuatable structure. By drawing a packing sleeve over the cylinder, the outer diameter of the cylinder can be increased.

The invention relates to a packing sleeve for a cylinder in a printing press. The invention relates furthermore to a method for varying the inner diameter of a packing sleeve.

In the graphics industry, especially in printing presses for web offset printing, sleeve-form cylinder packings, also known as packing sleeves, are often used. So that such packing sleeves are firmly connected during operation to the cylinder receiving them, it is customary to make the inner diameter of the packing sleeve slightly but sufficiently smaller than the outer diameter of the cylinder receiving it, so that in the mounted state the deformation or extension of the packing sleeve produces a dynamic recovery force. To change the fastening state of the packing sleeve, that is, for mounting or demounting, the inner diameter of the packing sleeve is enlarged by the action of force: a common method is described, for example, in the document U.S. Pat. No. 6,368,100 B. A current of air is able to escape from the presenting cylinder such that an air bubble is produced and a dynamic effect is exerted on the packing sleeve in order to extend it. It is preferable to be able to avoid such a complex auxiliary device.

It is an object of the present invention to produce a packing sleeve that allows simple mounting on or demounting from a cylinder in a printing press.

That object is achieved in accordance with the invention by a packing sleeve for a cylinder in a printing press having the features according to claim 1. Advantageous developments of the invention are characterised in the dependent claims.

According to the invention a packing sleeve suitable for a cylinder, especially a printing plate cylinder or a blanket cylinder, in a printing press comprises an evacuatable structure of voids. The packing sleeve can also be called in particular an intermediate sleeve for a printing plate or a blanket. The term void or voids is meant to denote all different kinds of macroscopic openings or macroscopic hollow spaces in the packing sleeve, especially cavities, caverns, hollows, passageways, cells, honeycombs and channels. The outer lateral surface of the packing sleeve can in particular be seamless.

The evacuatable structure of voids and/or the shaping of the voids are/is carried out such that when a negative pressure is generated in the evacuatable structure the inner diameter of the packing sleeve increases and/or the outer diameter of the packing sleeve decreases. In this way, mounting on or demounting from a receiving cylinder that is of slightly larger diameter than the inner diameter of the packing sleeve in the force-free state is facilitated.

In a preferred embodiment of the packing sleeve, the evacuatable structure can comprise a plurality of individual voids, and/or several voids of the evacuatable structure can be connected with one another. The structure can consequently also be referred to as a system or network of voids.

Alternatively or additionally, in an advantageous construction of the packing sleeve according to the invention the voids can run substantially parallel to the figure axis of the packing sleeve, especially the axis of rotation or main axis of the substantially rotationally symmetric packing sleeve.

For use as an intermediate sleeve on a blanket cylinder, the outer lateral surface of the packing sleeve according to the invention preferably represents substantially the lateral surface of a right-circular cylinder.

For use as an intermediate sleeve on a printing plate cylinder, the packing sleeve preferably has in its outer lateral surface at least one recess for fixing a plate-form cylinder packing.

In an advantageous embodiment, the packing sleeve has at its inner lateral surface at least one recess or one projection. Such recesses or projections are provided for correspondingly inversely formed projections or recesses on the receiving cylinder, so that fixing of the packing sleeve, especially in the azimuthal direction, can be achieved.

In one embodiment, the packing sleeve according to the invention comprises at least one annular lateral plate, which comprises a cavity or a hollow space connected with the evacuatable structure. An evacuating device, for example a vacuum pump, can be connected to this cavity.

Linked to the inventive concept is also a method for varying the internal diameter of a packing sleeve, as is disclosed in this description. In the method according to the invention, a negative pressure is applied to the evacuatable structure of the packing sleeve. In particular, the method according to the invention can be carried out during a change in the fixing state of the packing sleeve on a cylinder in a printing press, the inner diameter of the packing sleeve being increased by the application of negative pressure. The mounting or demounting of the packing sleeve on a cylinder having an outer diameter that is slightly larger than the inner diameter of the packing sleeve in the force-free state (with no negative pressure being applied) is thereby advantageously facilitated or simplified.

The packing sleeve according to the invention can advantageously be used to increase the effective diameter or the effective circumferential length of a cylinder in a printing press, especially a printing plate cylinder or a blanket cylinder (transfer cylinder). In other words, associated with the concept of the invention is the use according to the invention of a packing sleeve according to this description for increasing the outer diameter of a cylinder in a printing press, by drawing the packing sleeve over the cylinder in the printing press. It is immediately clear to the expert that to achieve a number of different effective circumferential lengths on a specific cylinder a number of packing sleeves of different thickness must be provided. The variation in the effective circumferential length is especially advantageous for the technique of web offset printing, in order to achieve a variable printing length.

Further advantages and advantageous embodiments and developments of the invention are explained with reference to the following Figures and the description thereof. In the Figures:

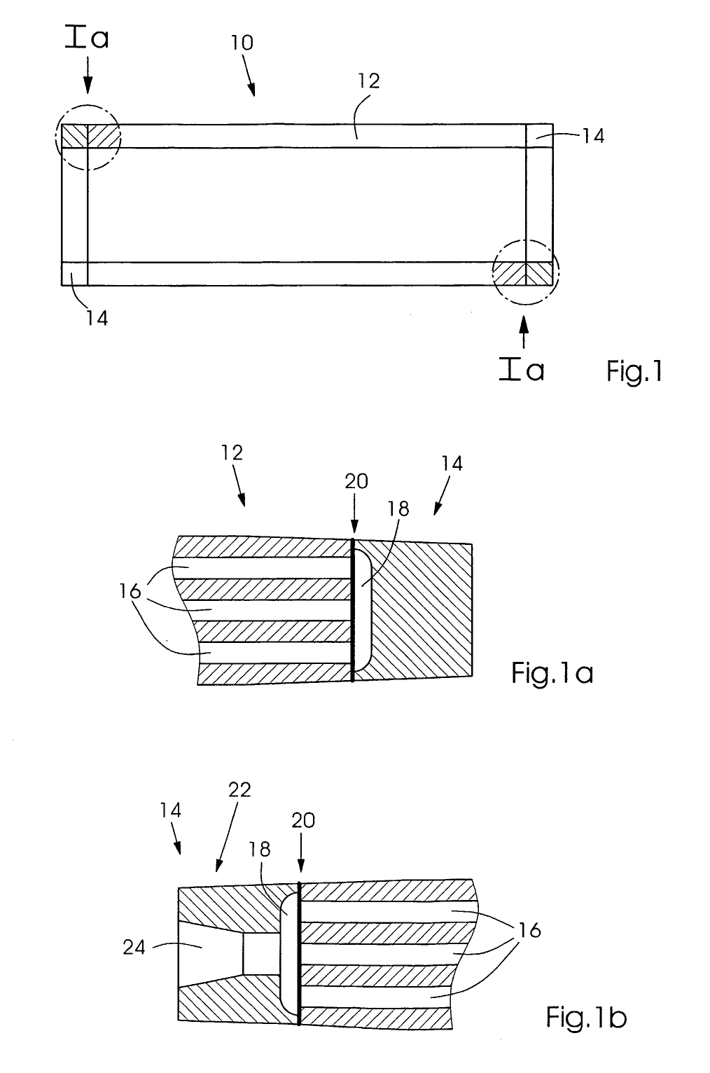

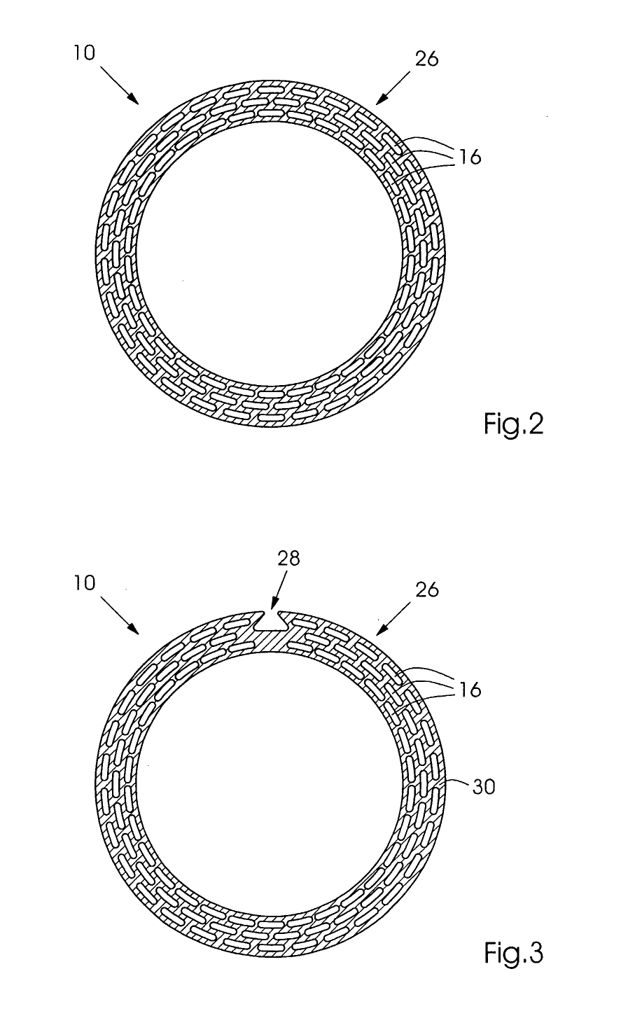

FIG. 1 is a schematic representation of an embodiment of a packing sleeve according to the invention together with details in FIG. 1a and FIG. 1b, FIG. 2 shows an embodiment of a packing sleeve according to the invention for a blanket cylinder,

FIG. 3 shows an embodiment of a packing sleeve according to the invention for a printing plate cylinder,

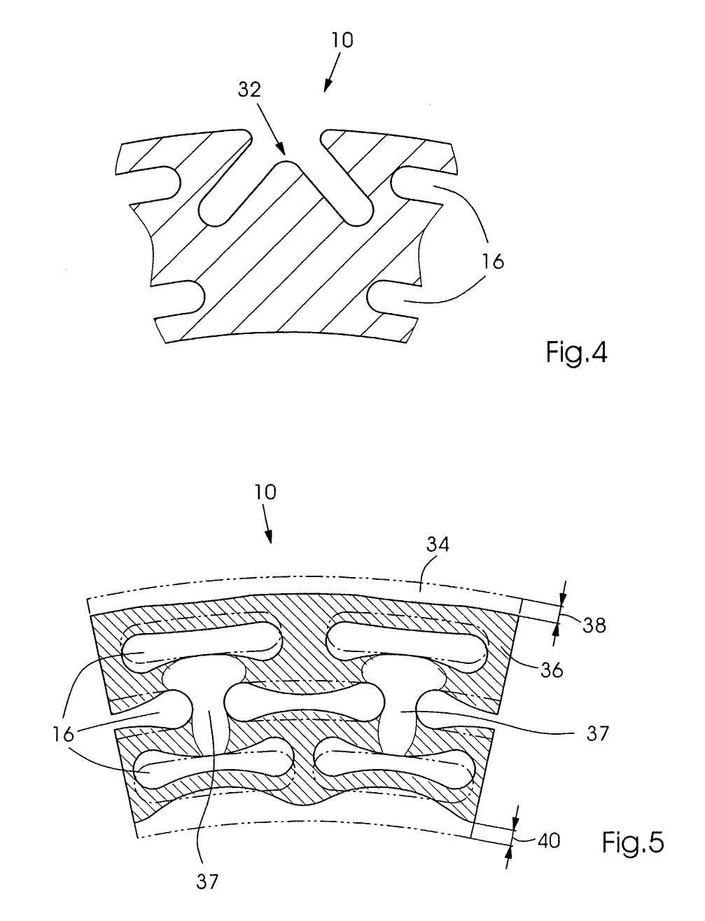

FIG. 4 is a partial view of an alternative embodiment of a packing sleeve according to the invention for a printing plate cylinder,

FIG. 5 is a schematic representation to explain the deformation behaviour when the packing sleeve according to the invention is evacuated, and

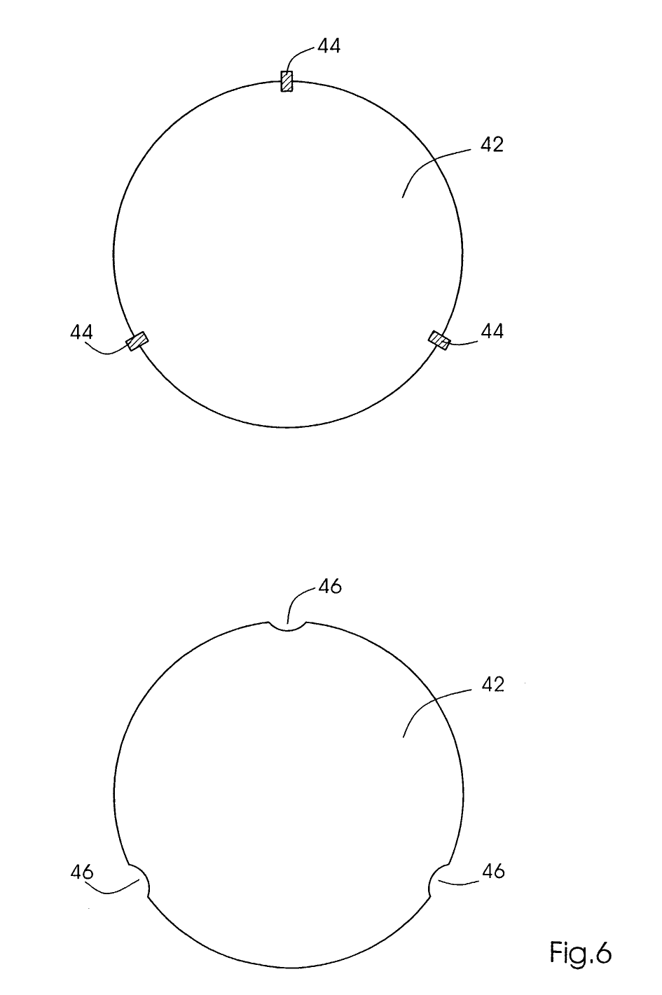

FIG. 6 is a schematic representation of two cylinders, on which more sophisticated embodiments of the packing sleeve according to the invention can be received.

FIG. 1 shows a schematic representation of an embodiment of a packing sleeve according to the invention together with details in FIG. 1a and FIG. 1b. In this embodiment, the packing sleeve 10 according to the invention comprises a tube 12, at each end of which a lateral plate 14 in the form of a ring is arranged, so that the packing sleeve 10 can be drawn over a receiving cylinder substantially parallel to the figure axis thereof. Fixing of the lateral plates 14 to the tube 12 can be effected by an adhesive joint 20. The details of FIG. 1a and FIG. 1b show respective enlarged cut-outs. In the detail of FIG. 1a, the tube 12 is seen to have an evacuatable structure of voids 16, which run substantially parallel to the figure axis of the packing sleeve 10. These voids 16 are connected to a cavity 18 in the lateral plate 14. The lateral plate 14 has a chamfer of small angle 22. An evacuating means, for example, a vacuum pump, can be connected to an opening 24 in order to create a negative pressure in the evacuatable structure of voids 16. This negative pressure causes a contraction, i.e. the decrease in the outer diameter and the increase in the inner diameter (see also FIG. 5) of the packing sleeve 10, typically by 1 to 2 hundredths of a millimetre. In the detail of FIG. 1b, the lateral plate 14 is seen to have a cavity 18 that connects the voids 16 of the evacuatable structure. In other words, there is a system or a network of conjoined voids 16 in this embodiment of the packing sleeve 10 according to the invention. For construction of the packing sleeve 10 according to the invention, a material having a low modulus of elasticity is used, so that mounting on or demounting from a receiving cylinder is facilitated. For printing mode, the packing sleeve preferably advantageously also has a coefficient of thermal expansion slightly lower than that of the steel of the receiving cylinder.

In the state under a negative pressure, that is, when the inner diameter is enlarged, the packing sleeve 10 can be easily and conveniently received on a cylinder or removed from the cylinder. The small angle 22 mentioned helps to position the extreme regions of the packing sleeve 10 in the printing press. Since the outer diameter is reduced, a printing plate or a blanket, especially a printing plate sleeve or a blanket sleeve, can be easily and conveniently mounted or demounted. For example, a plate-form printing plate can be fixed on the packing sleeve 10 away from the printing press, prior to mounting of the packing sleeve 10. The printing plate is then held under tension on the packing sleeve 10 when evacuation of the voids 16 terminates. A special, often complex printing plate-holding and/or printing plate-clamping device is no longer necessary. As already mentioned, packing sleeves according to the invention can be supplied in different formats (outer diameters), so that different printing lengths can be realised with a printing press having cylinders of a specific fixed format.

FIG. 2 illustrates an embodiment of a packing sleeve 10 according to the invention for a blanket cylinder. This packing sleeve 10 comprises a regular structure 26 of voids 16. The voids 16, here having a stadium-shaped cross-sectional area, run substantially parallel to the axis of rotational symmetry of the packing sleeve 10. There are concentrically arranged groups of voids 16, here three groups at different distances from the axis of rotational symmetry. Individual voids 16 in a group are located azimuthally offset with respect to adjacent voids in adjacent groups. Such a regular structure 26 can also be called a honeycomb structure.

FIG. 3 is a schematic illustration relating to an embodiment of a packing sleeve 10 according to the invention for a printing plate cylinder. Akin to the embodiment shown in FIG. 2, this packing sleeve also has a honeycomb structure. A trapezoidal recess 28, which serves to receive bent-over edges of a plate-form printing plate, is provided in the outer lateral surface 30. The bent-over edges can be introduced into the recess 28 when the packing sleeve 10 is under a negative pressure.

FIG. 4 is a schematic partial view of an alternative embodiment of a packing sleeve 10 according to the invention with an evacuatable structure of voids 16 for a printing plate cylinder. As an alternative to a trapezoidal recess 28, as shown in FIG. 3, in this embodiment a V-shaped recess 32 for receiving the bent-over edges or a printing plate is provided. The web between the arms of the V-shaped recess additionally stabilises the position of the bent-over edges in the recess.

FIG. 5 shows a schematic representation for explanation of the deformation behaviour when the packing sleeve 10 according to the invention is evacuated. A cut-out of an embodiment of a packing sleeve 10 according to the invention is shown in two states: the broken outline represents the undeformed packing sleeve 10, that is, the undeformed state 34, the solid outline shows the packing sleeve 10 deformed by evacuation of the voids 16, that is, the deformed state 36. The evacuatable structure of the voids 16 is selected or constructed so that both a decrease in the inner diameter and an increase in the inner diameter are achieved. In FIG. 5, it can clearly be seen that the middle part 37 (not shown by a broken line) of the evacuatable structure, the webs between the voids 16 of the middle group of voids 16, remains substantially unchanged in shape and position, so that the deformation of the packing sleeve occurs especially at the inner and outer lateral surfaces. Applying negative pressure consequently leads to a variation 38 of the outer radius and a variation 40 of the inner radius of the packing sleeve 10 according to the invention.

FIG. 6 shows schematically two cylinders on which more sophisticated embodiments of the packing sleeve according to the invention can be received. As already mentioned, in advantageous embodiments of the packing sleeve according to the invention, recesses or projections can be arranged at the inner lateral surface of the packing sleeve. These shapings then correspond to inverse shapings on the receiving cylinder. The upper part of FIG. 6 shows by way of example a cylinder 42 receiving a packing sleeve 10 according to the invention, the cylinder having stops 44 on its outer lateral surface, here three stops distributed uniformly around the full circle. These stops 44 project beyond the outer lateral surface of the cylinder 42 and engage in recesses, not shown here, at the inner lateral surface of a packing sleeve 10 according to the invention to be received on the cylinder.

The lower part of FIG. 6 shows, as an alternative or in addition to the projections already described, that a cylinder 42 receiving a packing sleeve 10 according to the invention can have recesses 46 arranged on the outer lateral surface, here three recesses distributed uniformly around the full circle. These recesses 46 receive projections, not shown here, on the inner lateral surface of a packing sleeve 10 according to the invention to be received on the cylinder. In this way, a rotation of the packing sleeve 10 relative to the cylinder can advantageously be prevented.

For the expert to whom this explanation is directed, it is immediately clear that a packing sleeve according to the invention can also be constructed so that it is possible to apply an overpressure to it, so that if necessary a specific shaping or a specific stiffness can be achieved.

### LIST OF REFERENCE NUMERALS

10 Packing sleeve
12 Tube
14 Lateral plate
16 Void
18 Cavity
20 Adhesive joint
22 Small angle
24 Opening
26 Evacuatable structure
28 Recess
30 Outer lateral surface
32 V-shaped recess
34 Undeformed state
36 Deformed state
38 Variation of outer radius
40 Variation of inner radius
42 Cylinder
44 Stop
46 Recess

What is claimed is:

1-10. (canceled)

11. A packing sleeve for a cylinder in a printing press comprising an evacuatable structure of voids.

12. The packing sleeve as recited in claim 11 wherein the evacuatable structure of voids includes a plurality of individual voids or a plurality of voids of the evacuatable structure are connected.

13. The packing sleeve as recited in claim 11 wherein the voids run substantially parallel to the figure axis of the packing sleeve.

14. The packing sleeve as recited in claim 11 wherein the packing sleeve includes an outer lateral surface, the outer lateral surface being the lateral surface of a right-circular cylinder.

15. The packing sleeve as recited in claim 14 wherein the outer lateral surface includes at least one recess fixing a plate-form cylinder packing.

16. The packing sleeve as recited claim 11 wherein the packing sleeve includes an inner lateral surface having at least one recess or one projection.

17. The packing sleeve as recited in claim 11 further comprising at least one annular lateral plate including a cavity connected to the evacuatable structure.

18. A method for varying the inner diameter of a packing sleeve for a cylinder in a printing press comprising an evacuatable structure of voids comprising the step of:
applying a negative pressure to the evacuatable structure of voids.

19. The method as recited in claim 18 wherein the step of applying a negative pressure occurs during a change in a fixing state of the packing sleeve and increases the inner diameter of the packing sleeve.

20. A method for increasing the outer diameter of a cylinder in a printing press comprising the step of:
drawing the packing sleeve as recited in claim 11 over the cylinder.
